(19) United States
(12) Patent Application Publication
(10) Pub. No.: US 2021/0275278 A1
(43) Pub. Date: Sep. 9, 2021

(54) DENTAL IRRIGATOR WATER TANK AND DENTAL IRRIGATOR

(71) Applicant: XIAMEN JIEBOYA TECHNOLOGY CO,LTD., Fujian (CN)

(72) Inventors: Mu YUAN, Fujian (CN); Caibo GU, Fujian (CN)

(73) Assignee: XIAMEN JIEBOYA TECHNOLOGY CO,LTD., Fujian (CN)

(21) Appl. No.: 16/907,177

(22) Filed: Jun. 20, 2020

(30) Foreign Application Priority Data
Mar. 4, 2020 (CN) 202020254536.7

(51) Int. Cl. A61C 1/00; A61C 17/02

(52) U.S. Cl. CPC A61C 1/0084; A61C 1/0076; A61C 17/0202

(57) ABSTRACT

A dental irrigator water tank and a dental irrigator are disclosed. The dental irrigator water tank is detachably attached to a side of a dental irrigator body, and the dental irrigator water tank extends below a lower surface of the dental irrigator body when the dental irrigator water tank is attached to the dental irrigator body. The dental irrigator includes the dental irrigator water tank and a dental irrigator body. The water tank of the dental irrigator reasonably uses the structure of the body of the dental irrigator, and increases a capacity of an inner cavity of the water tank. Further, the dental irrigator water tank is provided with a water pressure stabilizing unit to ensure that when the water level in the water tank changes, the dental irrigator can also ensure that the water output is uniform.

### CROSS-REFERENCE TO RELATED APPLICATION

This application claims the priority benefit of China application serial no. 202020254536.7, filed on Mar. 4, 2020. The entirety of the above-mentioned patent application is hereby incorporated by reference herein and made a part of this specification.

### BACKGROUND

### Technical Field

The present application relates to the field of dental cleaning appliances, in particular to a dental irrigator water tank and a dental irrigator.

### Description of Related Art

At present, the structure of a dental irrigator on the market mainly includes two main parts, namely a water tank and a dental irrigator body. The water tank is usually installed on a side wall of the dental irrigator body and a bottom end of the water tank is flush with a bottom end of the dental irrigator body. A body size of the dental irrigator is limited in order to facilitate the consumer to grip. Therefore, the capacity of the water tank cannot be effectively improved. Consumers often need to add water frequently during use, and the experience is not good.

### SUMMARY

The purpose of this present application is to overcome the above-mentioned defects or problems in the background, and provide a dental irrigator water tank and a dental irrigator, and the body structure of the dental irrigator is reasonably utilized and the capacity of inner cavity of the water tank is effectively increased. Further, since the depth of the dental irrigator water tank is large, the height difference is large when the water level changes, and when the pump with a certain pumping head is pumping, there is a problem that the water output and the impact force at high water level are large, but the water output and the impact force at low water level are insufficient. The dental irrigator water tank provided by the present application is provided with a water pressure stabilizing unit to ensure that when the water level in the water tank changes, the dental irrigator can still ensure that the water output is uniform, thereby ensuring the user experience.

To achieve the above purpose, the following technical solutions are adopted.

According to a first aspect of the present application, there is provided a dental irrigator water tank, detachably attached to a side of a dental irrigator body. The dental irrigator water tank extends below a lower surface of the dental irrigator body when the dental irrigator water tank is attached to the dental irrigator body. The dental irrigator water tank can make reasonable use of the space below the dental irrigator body, and effectively increase the capacity of the water tank without increasing the girth of the body of the dental irrigator. Due to the sufficient space available below the dental irrigator body, the effect of increasing the capacity of the water tank is good, thereby effectively reducing the frequency of adding water to the water tank, and improving the consumer experience.

Preferably, an outer surface of the dental irrigator water tank is smoothly joined with an outer surface of the dental irrigator body when the dental irrigator water tank is attached to the dental irrigator body, thereby ensuring the integrity of the body of the dental irrigator, the aesthetics and grip feel are better.

According to another aspect of the present invention, there is provided a dental irrigator, wherein the dental irrigator includes a dental irrigator body and the dental irrigator water tank as described above.

Preferably, the dental irrigator body is provided with a water supply channel and a pump body. Two ends of the water supply channel are respectively communicated with a water outlet end of the dental irrigator water tank and a water inlet end of the pump body, and an elastic water pressure stabilizing unit is provided in the water supply channel. The water pressure stabilizing unit is provided with a water passing hole, and a side wall of a water inlet end of the water pressure stabilizing unit is inclined. The water passing hole is always open.

When the water level in the dental irrigator water tank is falling, the water output pumped by the pump will change when the pumping head of the water pump is consistent. specifically, when the water level in the dental irrigator water tank is high, the vertical height between the water level in the dental irrigator water tank and the central axis of the pump body impeller is small, and a pump with a certain pumping head can pump a large amount of water, and the water pressure in the water supply channel is large, at this time, the side of the water inlet end of the water pressure stabilizing unit is deformed by the inlet water pressure and compressed into the water passing hole, thereby reducing a water passing area of the water passing hole, so that the water output is not too large. When the water level in the dental irrigator water tank gradually decreases, the vertical height between the water level in the dental irrigator water tank and the central axis of the pump body impeller is high, the amount of water that can be drawn by a pump with a certain pumping head and the water pressure in the water supply channel gradually decrease, at this time, the degree of deformation of the side of the water inlet end of the water pressure stabilizing unit affected by the water inlet pressure gradually weakens. Therefore, the water passing area of the water passing hole gradually increases in this process. This ensures that the water output of the dental irrigator will not be reduced and uniform water output can be maintained at all times when the pumping head changes, so as to avoid giving a user a feeling of unstable water output and different impact of water output, thereby guaranteeing the user's experience.

Since the volume of the portion of the dental irrigator water tank located below the dental irrigator body is generally much larger than the volume of the portion of the dental irrigator water tank located beside the dental irrigator body, therefore, it takes a relatively long time for the dental irrigator body to pump water from the portion of the dental irrigator water tank located below the dental irrigator body, the setting of the water pressure stabilizing unit prevents the dental irrigator from going through a long period of time of small water output and small water impulse when the water level is below the dental irrigator body, thus the user experience is improved. In addition, in order to avoid that the water level and water impulse are too small when the water level of the dental irrigator is below the dental irrigator body, the pumping power of the water pump of the technical solution should be configured under the condition that the dental irrigator still has sufficient water output and water impulse even when the water level in the dental irrigator water tank reaches the minimum.

Preferably, the water inlet end of the water pressure stabilizing unit is duckbill-shaped. The duckbill-shaped water pressure stabilizing unit can not only guarantee reliable water passing, but also be more likely to be deformed when the inlet water pressure changes and change the water passing area of the water passing hole.

Preferably, the dental irrigator includes a spare water tank. The spare water tank and the dental irrigator water tank are used interchangeably.

Preferably, the spare water tank is detachably attached to the side of the dental irrigator body. A bottom end of the spare water tank is flush with a bottom end of the dental irrigator body when the spare water tank is attached to the dental irrigator body.

The additional spare water tank meets the replacement needs of consumers. The dental irrigator has at least one spare water tank, which satisfies the requirement that the bottom end of the spare water tank is flush with the bottom end of the dental irrigator body when the spare water tank is attached to the dental irrigator body, and the volume and capacity of the spare water tank is smaller than the dental irrigator water tank, which is convenient for consumers to carry when going out.

Preferably, a water inlet pipe is provided in the dental irrigator water tank. A water inlet end of the water inlet pipe extends to an inner bottom surface of the dental irrigator water tank, and a water outlet end of the water inlet pipe extends to an outer wall of the dental irrigator water tank. An outer wall of the dental irrigator body is provided with a water inlet, and the water outlet end of the water inlet pipe forms the water outlet end of the dental irrigator water tank. When the dental irrigator water tank is attached to the dental irrigator body, the water outlet end of the water inlet pipe is sealingly docked with the water inlet of the dental irrigator body.

Instead of fixing the water inlet pipe to the dental irrigator body in the traditional structure, the water inlet pipe in the dental irrigator of the present application is set in the dental irrigator water tank to prevent the water inlet pipe from being contaminated by being exposed to the air when adding water to the water tank, making it more hygienic during use. In addition, the situation where a length of the water inlet pipe is fixed and not conducive to the replacement of water tanks of different capacities is improved.

Preferably, the water inlet pipe is a rigid tube integrally formed with the dental irrigator water tank.

Preferably, the water inlet pipe is a hose fixedly connected to an inner cavity wall of the dental irrigator water tank.

Preferably, the water inlet end of the water inlet pipe is provided with a filter hole. The filter hole at the water inlet end of the water inlet pipe can prevent impurities of large particles from entering the dental irrigator, thereby preventing the function of the dental irrigator body from being damaged.

Preferably, the water outlet end of the water inlet pipe extends to a top wall of the inner cavity of the dental irrigator water tank. The outer wall of the dental irrigator body is provided with a connecting column extending downward, and the water inlet is provided in the connecting column. When the dental irrigator water tank is attached to the dental irrigator body, the connecting column is hermetically inserted into the water outlet end of the water inlet pipe.

Preferably, the dental irrigator body includes a nozzle, and a water outlet channel is further provided in the dental irrigator body. The nozzle is detachably provided at an upper end of the dental irrigator body and communicated with a water outlet end of the water outlet channel. An outer wall of the nozzle is provided with a limiting flange, and the limiting flange is close to a water inlet end of the nozzle. A water inlet end of the water outlet channel is communicated with a water outlet end of the pump body. A top wall of the dental irrigator water tank is provided with a mounting hole extending toward an inner cavity of the dental irrigator water tank, and a bottom wall of the mounting hole is provided with a through hole. When the nozzle is removed from the dental irrigator body and a water outlet end of the nozzle is inserted into the inner cavity of the dental irrigator water tank after penetrating the through hole, the limiting flange of the nozzle abuts the bottom wall of the mounting hole. When the dental irrigator water tank is attached to the dental irrigator body, the mounting hole is sealingly engaged with the dental irrigator body.

The nozzle can be stored in the water tank when not in use or when carried out, not only can it prevent the nozzle from being directly exposed to the air and be contaminated by bacteria or impurities, etc. in the unused state, but also reduce the space occupation when carrying, more convenient to carry, at the same time, the situation that the nozzle is bent when carrying out can also be avoided.

Preferably, the dental irrigator body further includes a protective cover. The protective cover is provided on the upper end of the dental irrigator body when the nozzle is in a storage state. The protective cover can prevent the water outlet end of the dental irrigator body from being contaminated by impurities or bacteria when the nozzle is contained in the water tank.

To make the aforementioned more comprehensible, several embodiments accompanied with drawings are described in detail as follows.

### BRIEF DESCRIPTION OF THE DRAWINGS

In order to explain the technical solution of the embodiment more clearly, the following drawings are briefly introduced.

FIG. 1 is a three-dimensional exploded schematic diagram of a dental irrigator according to an embodiment of the present application;

FIG. 2 is a first cross-sectional view of the dental irrigator according to the embodiment of the present application;

FIG. 3 is a second cross-sectional view of the dental irrigator according to the embodiment of the present application;

FIG. 4 is a schematic diagram of a housing according to the embodiment of the present application;

FIG. 5 is a schematic diagram of a water storage tank according to the embodiment of the present application;

FIG. 6 is a schematic diagram of a front surface of the housing according to the embodiment of the present application;

FIG. 7 is a schematic diagram of a case when a nozzle is being inserted into the housing according to the embodiment of the present application;

FIG. 8 is a schematic diagram of a water inlet end of a water inlet pipe in the water storage tank according to the embodiment of the present application;

FIG. 9 is a schematic diagram of a case when a first water storage tank and a dental irrigator body are connected according to the embodiment of the present application;

FIG. 10 is a schematic diagram of a case when a second water storage tank and the dental irrigator body are connected according to the embodiment of the present application; and

FIG. 11 is a schematic diagram of a case when a third water storage tank and the dental irrigator body are connected according to the embodiment of the present application.

### DESCRIPTION OF THE EMBODIMENTS

In the claims and the description, unless otherwise defined, the terms “first”, “second” or “third” are used to distinguish different objects, rather than to describe a specific order.

In the claims and the description, unless otherwise defined, the orientations or positional relationships indicated by the terms “center”, “landscape”, “portrait”, “horizontal”, “vertical”, “top”, “bottom”, “inner”, “outer”, “up”, “down”, “front”, “back”, “left”, “right”, “clockwise”, “counterclockwise” are based on the orientations and positional relationships shown in the drawings, and merely to simplify the description, not to imply that the device or element referred to must have a particular orientation or be constructed and operated in a particular orientation.

In the claims and description, unless otherwise defined, the terms “fixed connection” should be understood in a broad sense, that is, there is no connection mode between the two that has a displacement relationship and a relative rotation relationship, that is, it includes a non-detachable fixed connection, a detachable fixed connection, an integral connection, and a fixed connection through other devices or components.

In the claims and the description, unless otherwise defined, the terms “including”, “comprising” and their variations mean “including but not limited to”.

The technical solutions in the embodiments will be clearly and completely described below with reference to the accompanying drawings.

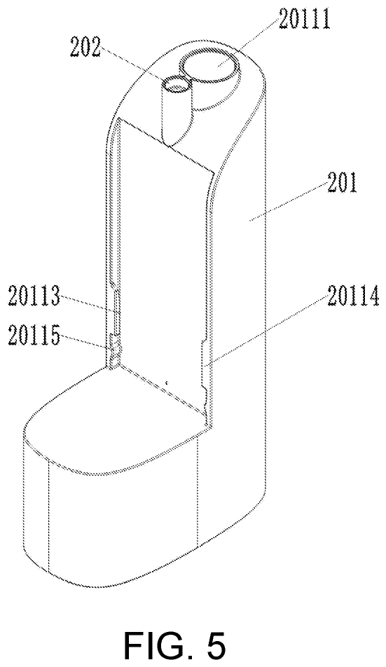

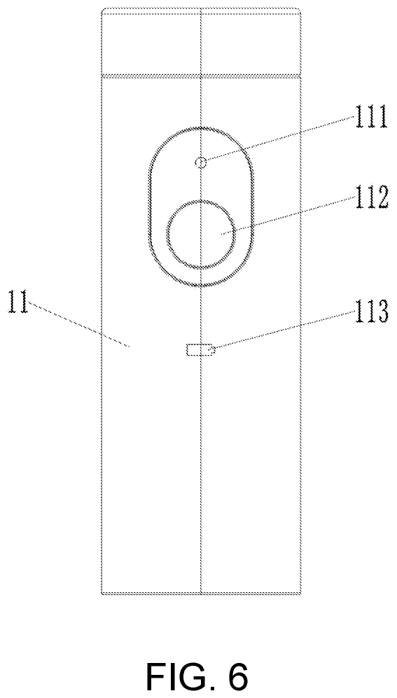

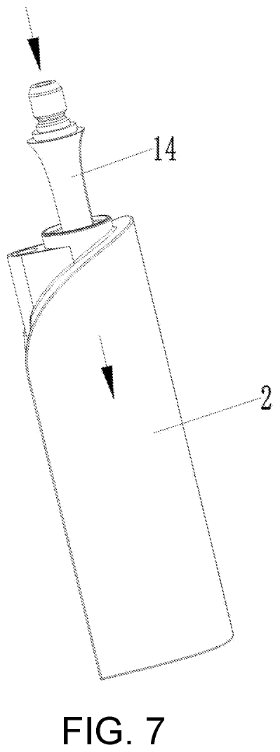

Referring to FIG. 5 to FIG. 11, FIG. 5 to FIG. 11 show a schematic structural diagram of a dental irrigator water tank 23 according to an embodiment of the present invention. As shown in FIG. 5 to FIG. 11, in this embodiment, the dental irrigator water tank 23 is used for detachably attaching to one side of the dental irrigator body 1. When the dental irrigator water tank 23 is attached to the dental irrigator body 1, the dental irrigator water tank 23 also extends below the lower surface of the irrigator body 1. In addition, an outer surface of the dental irrigator water tank 23 is smoothly joined with an outer surface of the dental irrigator body 1 to ensure the integrity of the body of the dental irrigator, and improve the appearance and grip feeling.

Specifically, the dental irrigator water tank 23 provided in this embodiment is generally L-shaped, and includes a body part 2011 and a capacity increasing part. The body part 2011 is detachably attached to a side wall of the dental irrigator body 1. The capacity increasing part is integrally formed on a lower end of the body part 2011, and an inner cavity of the capacity increasing part is communicated with an inner cavity of the body part 2011. The capacity increasing part extends toward a bottom end of the dental irrigator body 1 and covers the bottom end of the dental irrigator body 1 when the dental irrigator water tank 23 is attached to the dental irrigator body 1. The dental irrigator water tank 23 reasonably utilizes the space below the dental irrigator body 1, and effectively increases the capacity of the water tank without increasing the girth of the body of the dental irrigator. Moreover, since the space available below the dental irrigator body 1 is sufficient, the effect of increasing the capacity of the water tank is good, thereby effectively reducing the frequency of adding water to the water tank, and improving the consumer experience.

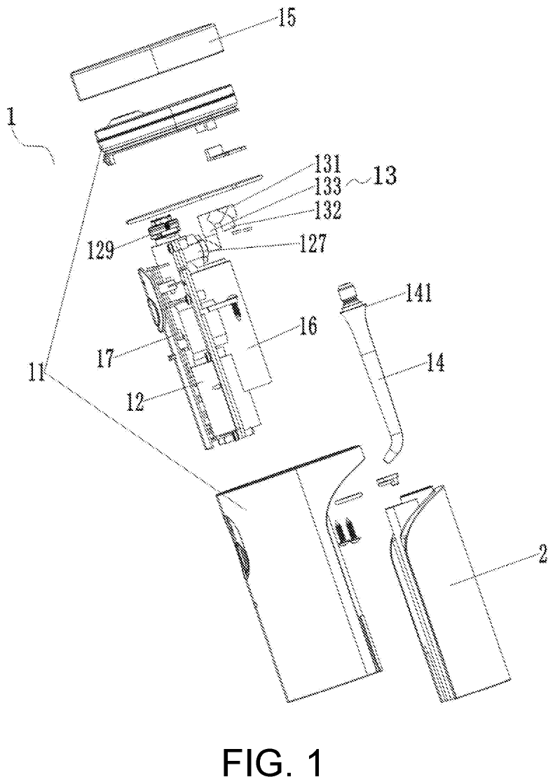

Referring to FIG. 1 to FIG. 11, FIG. 1 to FIG. 11 are schematic diagrams of a dental irrigator 100 according to an embodiment of the present application. As shown in FIG. 1 to FIG. 11, in this embodiment, the dental irrigator 100 includes a dental irrigator body 1, a water storage tank 2 and a sealing assembly 3. The dental irrigator body 1, the water storage tank 2 and the sealing assembly 3 are detachably fixed to each other.

Among them, the dental irrigator body 1 is provided with a water supply channel and a water outlet channel. Specifically, the dental irrigator body 1 includes a housing 11, a water pump assembly 12, a water supply pipe 13, a nozzle 14, a protective cover 15, a battery 16 and a controller 17.

In this embodiment, the housing 11 is a shell with a rear notch part formed on a lower rear side, and a notch part on a rear lower side of the housing 11 is used for attaching the water storage tank 2. When the water storage tank 2 and the housing 11 are connected in place, an outer wall of the water storage tank 2 and an outer wall of the housing 11 transit smoothly, and the overall shape of the dental irrigator 100 is formed into a substantially cylindrical shape that is easy to grip. In this embodiment, when viewed from the side of the housing 11, a shape of a cutting line of the notch part is defined by an upper arc and a vertical line joined to a lower end of the upper arc, a plane formed by cutting the housing 11 along the cutting line is the plane for the housing 11 to dock with the water storage tank 2. In this embodiment, a surface of the housing 11 docking with the water storage tank 2 is provided with a downward-facing plug-in post 114 and a connecting post 115 for forming a sealed fit with the water storage tank 2. A water inlet is provided at a lower end of the connecting column 115 for docking and communicating with the water storage tank 2, the water inlet of the connecting column 115 constitutes a water inlet end of the dental irrigator body 1. In addition, a first pipe column is provided on an inner wall of the housing 11, and the first pipe column is coaxial with the connecting column 115 and is provided with a column hole communicated with the water inlet of the connecting column 115.

The water pump assembly 12, the water supply pipe 13, the battery 16 and the controller 17 are located in the housing 11. A front face of the housing 11 is provided with a dental cleaning button 111, a stop button 112 and a power indicator 113. Among them, the dental cleaning button 111 is used to control the dental irrigator 100 to enter a dental cleaning state, the stop button 112 is used to control the dental irrigator 100 to exit the dental cleaning state, and the power indicator 113 is used to indicate the remaining power of the battery 16.

One end of the water pump assembly 12 is communicated with a water outlet of the water supply pipe 13, and the other end of the water pump assembly 12 is communicated with a water inlet of the nozzle 14. When the dental irrigator 100 enters the dental cleaning state, the water pump assembly 12 sucks the dental cleaning fluid from the water storage tank 2 and sends it to the nozzle 14.

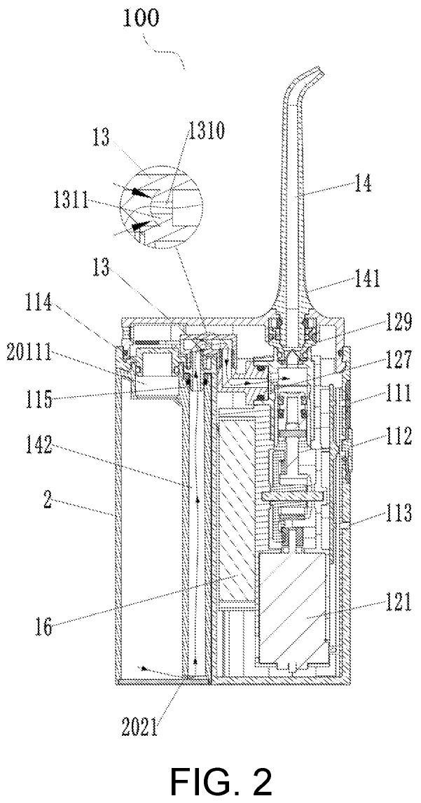

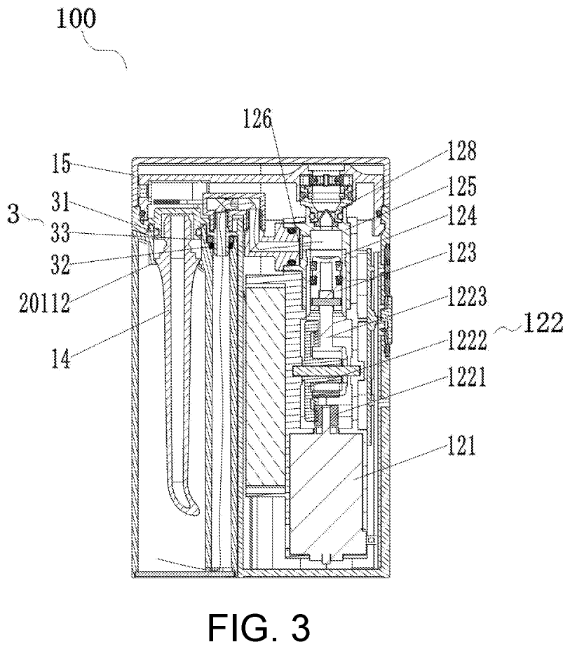

The specific structure of the water pump assembly 12 is shown in FIG. 2 and FIG. 3. As shown in FIG. 2 and FIG. 3, the water pump assembly 12 includes a motor 121, a transmission mechanism 122, a piston 123, a piston sleeve 124, a pump body 125, a first check valve plate 126, a first connecting seat 127, a second check valve plate 128 and a second connecting seat 129. Among them, the transmission mechanism 122 further includes a cylindrical gear 1221, a bevel gear 1222 and a connecting rod 1223. The motor 121 drives the cylindrical gear 1221 to rotate, and the cylindrical gear 1221 meshes with the bevel gear 1222, thereby the bevel gear 1222 is driven to rotate. One end of the connecting rod 1223 is eccentrically hinged with the bevel gear 1222, and the other end of the connecting rod 1223 is hinged with the piston 123, thereby a crank link mechanism is formed, so that the rotation of the bevel gear 1222 drives the piston 123 to move linearly in the piston sleeve 124, the piston sleeve 124 is arranged in the pump body 125, the pump body 125 is also provided with a water inlet and a water outlet, the water inlet of the pump body 125 is connected to the first connecting seat 127 through the first check valve plate 126, and the water outlet of the pump body 125 is connected to the second connecting seat 129 through the second check valve plate 128. The first check valve plate 126 only allows gas or liquid to flow from the first connecting seat 127 into the pump body 125, and does not allow gas or liquid to flow from the pump body 125 into the first connecting seat 127. The second check valve plate 128 only allows gas or liquid to flow from the pump body 125 into the second connecting seat 129, and does not allow gas or liquid to flow from the second connecting seat 129 into the pump body 125. In this embodiment, the first connecting seat 127 is used to connect the water outlet of the water supply pipe 13, and the second connecting seat 129 is used to connect the water inlet of the nozzle 14, thus, liquid or gas can be continuously extracted from the water storage tank 2 and delivered to the nozzle 14 through the water supply pipe 13.

The water supply pipe 13 is a soft pipe in this embodiment, including a straight pipe 131, a first connecting pipe 132 and a second connecting pipe 133 that are integrally formed. The first connecting pipe 132 and the second connecting pipe 133 face downward and are vertically communicated with the straight pipe 131, among them, the first connecting pipe 132 is hermetically sleeved on the first pipe column and communicated with the first pipe column; the second connecting pipe 133 is hermetically sleeved on a water inlet of the first connecting seat 127 and is communicated with the water inlet of the first connecting seat 127. The straight pipe 131 in the water supply pipe 13 forms a part of the water supply channel.

In this embodiment, as shown in FIG. 2 and FIG. 3, an elastic water pressure stabilizing unit 1311 is provided in the straight pipe 131 of the water supply pipe 13. The water pressure stabilizing unit 1311 is provided with a water passing hole 1310, a side wall of a water inlet end of the water pressure stabilizing unit 1311 is inclined, that is, an end surface of the water inlet end of the water pressure stabilizing unit 1311 is a convex surface, thus when the water pressure in the water supply pipe 13 changes, the water pressure stabilizing unit 1311 can be squeezed and deformed by the water pressure and change a water passing area of the water passing hole 1310, and the purpose of stabilizing the water flow of the dental irrigator 100 is achieved. It should be understood that the water passing hole 1310 proposed here is communicated with a water inlet end and a water outlet end of the water supply pipe 13.

Preferably, the water inlet end of the water pressure stabilizing unit 1311 in this embodiment is duckbill-shaped, the water pressure stabilizing unit can not only pass water reliably, but also be more sensitive to water pressure, therefore, the water pressure stabilizing unit is easier to deform and change the water passing area of the water passing hole when the inlet water pressure changes. Specially, the water pressure stabilizing unit 1311 is integrally formed in the straight pipe 131 of the water supply pipe 13, and an outer peripheral wall of the water pressure stabilizing unit 1311 is integrally fixed with an inner wall of the straight pipe 131, the water pressure stabilizing unit has good structural stability and is not easy to be moved by the impact of water flow, and it is also conducive to controlling the manufacturing cost of materials.

In this embodiment, the water supply channel of the dental irrigator body 1 is composed of an inner hole channel of the connecting column 115, the column hole of the first pipe column, a straight pipe portion of the water supply pipe 13 and an inner hole channel of the first connecting seat 127, which are sequentially connected. The water outlet channel of the dental irrigator body 1 is composed of an inner hole channel of the second connecting seat 129. A water inlet end of the water supply channel is communicated with a water outlet end of the water storage tank 2, and a water outlet end of the water supply channel is communicated with the water inlet of the pump. The water inlet end of the water outlet channel is communicated with the water outlet of the pump body, and the water outlet end of the water outlet channel is communicated with a water inlet end of the nozzle 14.

The nozzle 14 is detachably provided on an upper end of the dental irrigator body 1, specifically, the nozzle 14 in this embodiment is a long tube curved on the side of a water outlet end of the nozzle 14, a small hole is provided at the water outlet end of the nozzle 14 for the dental cleaning liquid to be sprayed out in a thin line to facilitate cleaning of teeth or gaps between teeth. An outer wall of the nozzle 14 is provided with a trumpet-shaped limiting flange 141, and the limiting flange 141 is close to the water inlet side of the nozzle 14. An upper end of the housing 11 of the dental irrigator body 1 is formed with a receiving through hole, and a sealing member such as a sealing ring is installed in the receiving through hole. The receiving through hole is provided for sealing insertion of a side of the water inlet end of the nozzle 14.

When the nozzle 14 is inserted into the housing 11 in position, an enlarged end of the limiting flange 141 abuts an upper end surface of the housing 11, and the side of the water inlet end of the nozzle 14 is sealingly inserted into the second connecting seat 129 and is communicated with the inner hole channel of the second connecting seat 129.

Preferably, the nozzle 14 can be mated with or detached from the receiving through hole, after the nozzle 14 is detached from the housing 11, the nozzle 14 can be accommodated in the water storage tank 2, thereby achieving the purpose of preventing the nozzle 14 from being directly exposed to the air and being attached or contaminated by bacteria or impurities when the dental irrigator 100 is not in use. At the same time, the space occupied during carrying can be reduced and carrying is more convenient. In addition, the situation that the nozzle 14 is bent during carrying can be avoided.

The protective cover 15 in this embodiment is a cover body having a shape matching the shape of the end of the housing 11 to which the nozzle 14 is attached, so as to cover the upper end of the housing 11 when the nozzle 14 is removed from the receiving through hole of the housing 11 and accommodated in the water storage tank 2, thereby preventing bacteria or impurities from attaching to the receiving through hole to pollute water supply channel of the housing 11.

The battery 16 is a rechargeable battery in this embodiment, which is used to power the water pump assembly 12 and the controller 17.

The controller 17 is configured to receive a dental cleaning instruction from the dental cleaning button 111 and a stop instruction from the stop button 112, and control the motor 121 to start or stop.

The number of water storage tanks 2 is at least two. Each water storage tank 2 is used interchangeably, and each water storage tank 2 is provided with an inner cavity, and the volume of each inner cavity is different. In this embodiment, each of the water storage tanks 2 is fixedly provided with a water inlet pipe 202, and a water inlet end of the water inlet pipe 202 extends to an inner bottom surface of the dental irrigator water tank 23. The water inlet pipe 202 is used for supplying dental cleaning liquid to the dental irrigator body 1, the outer wall of the water storage tank 2 is smoothly joined with the outer wall of the housing 11 after the water storage tank 2 is attached to the housing 11 in place, that is, at least a part of the shape of the water storage tank 2 needs to match the shape of the notch part on the lower rear side of the housing 11, so as to improve the grip feeling and convenience. In this embodiment, a length of each water inlet pipe 202 should be adapted to the depth of the corresponding water storage tank 2, ensuring that the water inlet end of the water inlet pipe 202 can extend to an inner bottom surface of the water storage tank 2 and completely absorb the dental cleaning fluid in the water storage tank 2.

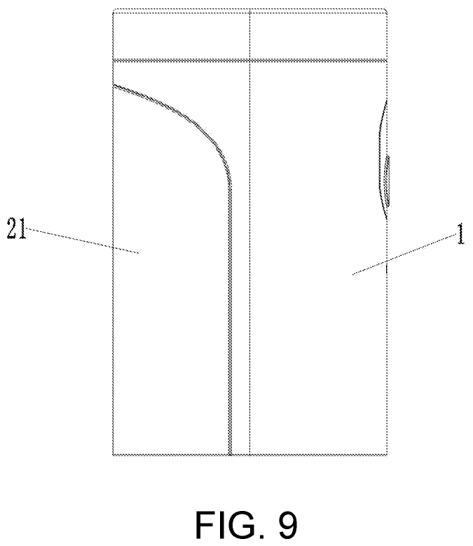

As shown in FIG. 9 to FIG. 11, in this embodiment, three water storage tanks 2 are selected, including one replaceable dental irrigator water tank 23 and two spare water tanks, specifically, the two spare water tanks are respectively a first water tank 21 and a second water tank 22. The dental irrigator water tank 23, the first water tank 21 and the second water tank 22 all include a tank body 201 and a water inlet pipe 202 integrally formed with the tank body 201 .

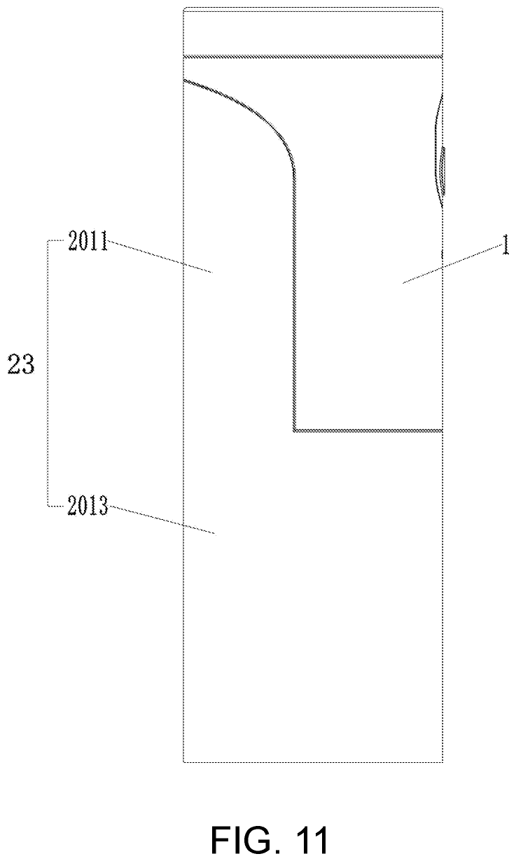

Specifically, as shown in FIG. 11, the dental irrigator water tank 23 is the dental irrigator water tank 23 provided in the above embodiment, and the tank body 201 of the dental irrigator water tank 23 includes a body part 2011 and a first capacity increasing part 2013. The body part 2011 is detachably attached to the notch part of the dental irrigator body 1, and the shape of the body part 2011 matches the notch part to ensure that the outer surface of the dental irrigator water tank 23 and the dental irrigator body 1 can be smoothly joined and the shape of the dental irrigator can be substantially cylindrical. The first capacity increasing part 2013 is integrally fixed to the lower end of the body part 2011 of the dental irrigator water tank 23, and an inner cavity of the first capacity increasing part 2013 is communicated with the inner cavity of the body part 2011 of the dental irrigator water tank 23, when the dental irrigator water tank 23 is attached to the dental irrigator body 1, the first capacity increasing part 2013 is connected to and covers a bottom end of the housing 11, and the first capacity increasing part 2013 constitutes a base of the dental irrigator 100. The water inlet end of the water inlet pipe 202 on the dental irrigator water tank 23 extends to the inner bottom surface of the dental irrigator water tank 23, and a water outlet end of the water inlet pipe 202 extends to an outer wall of the dental irrigator water tank 23 and forms the water outlet of the dental irrigator water tank 23, the water outlet end of the water inlet pipe 202 in the dental irrigator water tank 23 is sealingly connected with the water inlet of the dental irrigator body 1 when the dental irrigator water tank 23 is attached to the dental irrigator body 1.

As shown in FIG. 9, the capacity of the first water tank 21 used as a spare water tank is the smallest, the outer shape of the first water tank 21 is consistent with the outer shape of the body part 2011 of the dental irrigator water tank 23, and a bottom end of the first water tank 21 is closed. The bottom end of the first water tank 21 is flush with the bottom end of the dental irrigator body 1 when the first water tank 21 is attached to the dental irrigator body 1. The water inlet end of the water inlet pipe 202 on the first water tank 21 extends to an inner bottom surface of the first water tank 21, and the water outlet end of the water inlet pipe 202 extends to an outer wall of the first water tank 21, the water outlet end of the water inlet pipe 202 on the first water tank 21 is sealingly connected to the water inlet of the dental irrigator body 1 when the first water tank 21 is attached to the dental irrigator body 1.

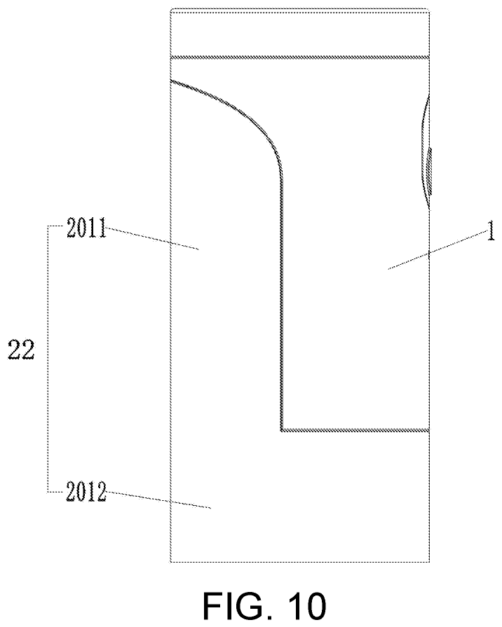

As shown in FIG. 10, another second water tank 22 serving as a spare water tank adopts the same structural as the dental irrigator water tank 23 provided in the above embodiment, and the tank body 201 of the second water tank 22 includes a body part 2011 and a second capacity increasing part 2012. The body part 2011 of the second water tank 22 is detachably attached to the notch part of the dental irrigator body 1, and the shape of the body part 2011 matches the notch part to ensure that the outer surface of the second water tank 22 and the dental irrigator body 1 can be smoothly joined and the shape of the dental irrigator can be substantially cylindrical. The second capacity increasing part 2012 is integrally fixed to the lower end of the body part 2011 of the second water tank 22, and an inner cavity of the second capacity increasing part 2012 is communicated with the inner cavity of the body part 2011 of the second water tank 22, the cross-sectional shape of the second capacity increasing part 2012 is the same as that of the first capacity increasing part 2013, but a height of the second capacity increasing part 2012 is smaller than a height of the first capacity increasing part 2013. When the second water tank 22 is attached to the dental irrigator body 1, the second capacity increasing part 2012 is connected to and covers the bottom end of the housing 11, and the second capacity increasing part 2012 constitutes the base of the dental irrigator 100. The water inlet end of the water inlet pipe 202 on the second water tank 22 extends to an inner bottom surface of the second water tank 22, and the water outlet end of the water inlet pipe 202 extends to an outer wall of the second water tank 22, the water outlet end of the water inlet pipe 202 in the second water tank 22 is sealingly connected with the water inlet of the dental irrigator body 1 when the second water tank 22 is attached to the dental irrigator body 1.

After the above-mentioned nozzle 14 is detached from the housing 11, the solution that the nozzle 14 can be accommodated in the dental irrigator water tank 23 or the spare water tank is specifically implemented in the following manner. A top wall of the dental irrigator water tank 23 is provided with a mounting hole 20111 extending toward an inner cavity of the dental irrigator water tank 23, and a top wall of the spare water tank is provided with a mounting hole 20111 extending toward an inner cavity of the spare water tank. A bottom wall of each mounting hole 20111 is provided with a through hole. The through hole is used for the water outlet end of the nozzle 14 to penetrate therethrough, and the bottom wall of each mounting hole 20111 constitutes a hooking part 20112. When the nozzle 14 is removed from the dental irrigator body 1 and the water outlet end of the nozzle 14 penetrates the through hole and is placed in the inner cavity of the dental irrigator water tank 23 or the spare water tanks, the side of the water outlet end of the nozzle 14 is accommodated in the inner cavity of the dental irrigator water tank 23 or the spare water tanks, and the limiting flange 141 is in abutment with the hooking part 20112. It should be understood that in order to avoid leakage of water from the mounting hole of the dental irrigator water tank 23 and the spare water tank during use, an upper edge of the mounting hole is in sealing fit with the dental irrigator body 1 when the dental irrigator water tank 23 or the spare water tank is attached to the dental irrigator body, specifically, the plug-in post 114 on the dental irrigator body 1 is sealingly plugged into an upper end of the mounting hole 20112 when the dental irrigator water tank 23 or the spare water tank is attached to the dental irrigator body 1.

During the pumping process of the water pump assembly 12, changes of the water level in the water tank will affect the water output of the water pump assembly 12 and affect the user experience. In order to solve the above-mentioned problems, as described above, the purpose of adjusting the water output can be well achieved by providing a water pressure stabilizing unit 1311 in the water supply pipe 13 of the dental irrigator body 1 in this embodiment, specifically, when the water level in the dental irrigator water tank 23 or the spare water tank is high, the vertical height between the water level in the dental irrigator water tank 23 and the central axis of the pump body impeller is small, and a pump with a certain pumping head can pump a large amount of water, and the water pressure in the water supply channel is large, at this time, the side of the water inlet end of the water pressure stabilizing unit 1311 is deformed by the inlet water pressure and compressed into the water passing hole, thereby reducing the water passing area of the water passing hole 1310, so that the water output is not too large. When the water level in the dental irrigator water tank 23 or the spare water tank gradually decreases, the vertical height between the water level in the dental irrigator water tank 23 and the central axis of the pump body impeller is high, the amount of water that can be drawn by a pump with a certain pumping head and the water pressure in the water supply channel gradually decrease, at this time, the degree of deformation of the side of the water inlet end of the water pressure stabilizing unit 1311 affected by the water inlet pressure gradually weakens, therefore, the water passing area of the water passing hole 1310 gradually increases in this process. This ensures that the water output of the dental irrigator 100 will not be reduced and uniform water output can be maintained at all times when the pumping head changes, so as to avoid giving a user a feeling of unstable water output and different impact of water output, thereby always ensuring consumers a better experience.

The embodiment provides three replaceable water tanks, which is convenient for users to choose according to their needs. Among them, the large-capacity water tank is suitable for home use, and the small-capacity water tank can be used for children or for carrying when going out, so as to better meet the needs of consumers.

In the embodiment, the water inlet pipe 202 adopts, but is not limited to, a vertical rigid pipe, and the water inlet pipe 202 is integrally formed in the dental irrigator water tank 23 or the spare water tank. It should be understood that the water inlet pipe 202 may also be a hose. When a hose is used, both ends of the water inlet pipe 202 need to be fixedly connected to the inner cavity wall of the water tank. It is worth noting that instead of being arranged on a top wall of the tank body 201, the water outlet end of the water inlet pipe 202 can also be arranged on a side wall or other positions of the tank body 201 according to actual needs.

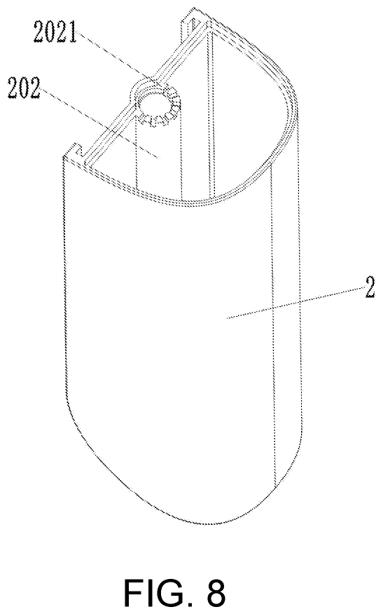

Preferably, as shown in FIG. 8, the water inlet end of the water inlet pipe 202 is provided with a plurality of filter holes 2021, the plurality of filter holes 2021 are circumferentially distributed at intervals on a wall of the water inlet pipe 202, in this way, it can play a role in filtering the impurities of large particles, thereby helping to protect the components in the dental irrigator body 1, prevent the water inlet pipe from being blocked and avoid damage to the function of the dental irrigator body 1.

Since the water inlet pipe 202 needs to form a sealing fit with the housing 11, in this embodiment, the end surface of the portion of the housing 11 for attaching the dental irrigator water tank 23 or the spare water tank is provided with a connecting column 115 extending downward, when the tank body 201 and the housing 11 are assembled in place, the connecting column 115 is hermetically inserted into the top of the water inlet pipe 202.

Generally speaking, the dental irrigator water tank 23 or the spare water tank can be detachably fixed to the rear side of the housing 11 of the dental irrigator body 1 by means of clamping. In this embodiment, the detachable connection between the housing 11 and the dental irrigator water tank 23 or the spare water tank is a sliding connection through the cooperation of a sliding groove and a sliding rail extending in a height direction to restrict them from being separated from each other in a non-sliding direction. By providing a clamping protrusion 20115 on the dental irrigator water tank 23 or the spare water tank, and providing a clamping groove 1171 on the dental irrigator body 1 matching the clamping protrusion 20115, the dental irrigator water tank 23 or the spare water tank and the irrigator body 1 are clamped and thus restricted from being separated from each other in a sliding connection direction when the dental irrigator water tank 23 or the spare water tank and the irrigator body 1 are mounted in place.

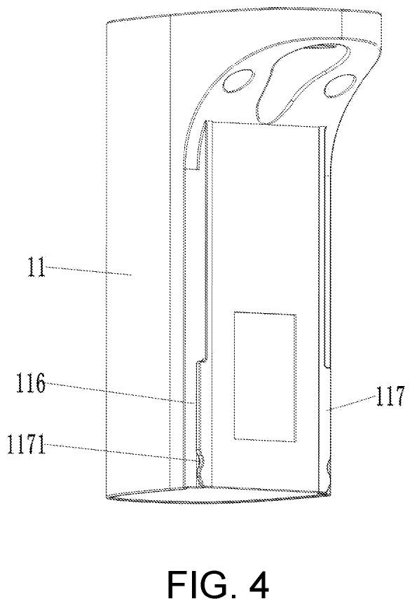

Specially, as shown in FIG. 4 and FIG. 5, a first sliding groove 116 and a first sliding plate 117 are formed on the side of the notch part of the housing 11 of the dental irrigator body 1, the first sliding groove 116 and the first sliding plate 117 extend to the bottom end of the housing 11, and the clamping groove 1171 is formed on the first sliding plate 117. The side of the dental irrigator water tank 23 and the side of the spare water tank for attaching the dental irrigator body 1 are both provided with a second sliding groove 20113 and a second sliding plate 20114 extending to the bottom end thereof, the second sliding groove 20113 is provided for the first sliding plate 117 to be slidingly connected with, the second sliding groove 20113 is provided with the clamping protrusion 20115 matched with the clamping groove 1171, so as to restrict the dental irrigator water tank 23 or the spare water tank to be separated from the dental irrigator body 1 in the sliding connection direction. The second sliding plate 20114 is used to form a sliding connection relationship with the first sliding groove 116. Arcuate surfaces are formed on upper and lower sides of the clamping protrusion 20115 in this embodiment in order to facilitate the disassembly and assembly of the dental irrigator water tank 23 or the spare water tank.

The sealing assembly 3 is used to realize the sealing relationship between the housing 11 and the dental irrigator water tank 23 or the spare water tank after being installed in place. The sealing assembly 3 includes a first sealing ring 31, a second sealing ring 32 and a sealing pad 33. The first sealing ring 31 is fixedly sleeved on an outer wall of the plug-in post 114. When the plug-in post 114 is mated with the mounting hole 20111, the first sealing ring 31 sealingly abuts against the outer wall of the plug-in post 114 and an inner wall of the mounting hole 20111. The second sealing ring 32 and the sealing pad 33 are sleeved in the water inlet pipe 202, specifically, an inner wall of the water inlet pipe 202 close to the outlet end of the water inlet pipe 202 is provided with two upward step surfaces, and the second sealing ring 32 and the sealing pad 33 are respectively sleeved on the two upward step surfaces and sealingly abut against an outer wall of the connecting column 115 and the inner wall of the water inlet pipe 202 when the connecting column 115 is inserted into the water inlet pipe 202.

In actual use, the user may slide the dental irrigator water tank 23, the second water tank 22, or the second water tank 21, all filled with dental cleaning fluid, from the bottom end of the dental irrigator body 1 according to the structural characteristics as described above and snap onto the dental irrigator body 1 according to needs. When being snapped in place, the tank body 201 is in a sealed state, and when the dental cleaning button 111 is pressed, the controller 17 controls the water pump assembly 12 to start, the pump body 125 draws water from the tank body 201 and sends the water to the nozzle 14, and the nozzle 14 ejects the linear shape dental cleaning fluid, and the user can start using it. When the user finishes using, press the stop button 112, the controller 17 controls the water pump assembly 12 to turn off, and the pump body 125 stops pumping water. When the dental irrigator 100 is not in use or needs to be carried out, the nozzle 14 is removed from the housing 11 and the tank body 201 is removed at the same time, and the nozzle 14 is inserted into the tank body 201 upside down from the mounting hole 20111 of the tank body 201, then, the nozzle 14 and the entire dental irrigator body 1 can be protected by reattaching the tank body 201 to the dental irrigator body 1 and placing the protective cover 15 on the end of the housing 11 provided with the receiving through hole.

By adopting the technical solutions in the above embodiments, the present application achieves the technical purpose that the water storage tank 2 of the dental irrigator 100 is replaceable and the capacity of the water storage tank 2 can be selected as needed, at the same time, the purpose that the water output are maintained the same during the use of the dental irrigator 100 is achieved.

The descriptions of the above specification and embodiments are used to explain the protection scope of the present application, but do not constitute a limitation on the protection scope of the present application.

What is claimed is:

1. A dental irrigator water tank, detachably attached to a side of a dental irrigator body, wherein the dental irrigator water tank extends below a lower surface of the dental irrigator body when the dental irrigator water tank is attached to the dental irrigator body.

2. The dental irrigator water tank according to claim 1, wherein an outer surface of the dental irrigator water tank is smoothly joined with an outer surface of the dental irrigator body when the dental irrigator water tank is attached to the dental irrigator body.

3. A dental irrigator, comprising a dental irrigator body and the dental irrigator water tank according to claim 1.

4. The dental irrigator according to claim 3, wherein the dental irrigator body is provided with a water supply channel and a pump body; two ends of the water supply channel are respectively communicated with a water outlet end of the dental irrigator water tank and a water inlet end of the pump body, and an elastic water pressure stabilizing unit is provided in the water supply channel; the water pressure stabilizing unit is provided with a water passing hole, and a side wall of a water inlet end of the water pressure stabilizing unit is inclined; the water passing hole is always open.

5. The dental irrigator according to claim 4, wherein the water inlet end of the water pressure stabilizing unit is duckbill-shaped.

6. The dental irrigator according to claim 4, further comprising a spare water tank; wherein the spare water tank and the dental irrigator water tank are used interchangeably.

7. The dental irrigator according to claim 6, wherein the spare water tank is detachably attached to the side of the dental irrigator body, and a bottom end of the spare water tank is flush with a bottom end of the dental irrigator body when the spare water tank is attached to the dental irrigator body.

8. The dental irrigator according to claim 4, wherein a water inlet pipe is provided in the dental irrigator water tank; a water inlet end of the water inlet pipe extends to an inner bottom surface of the dental irrigator water tank, and a water outlet end of the water inlet pipe extends to an outer wall of the dental irrigator water tank, the water outlet end of the water inlet pipe forms the water outlet end of the dental irrigator water tank;
wherein an outer wall of the dental irrigator body is provided with a water inlet; when the dental irrigator water tank is attached to the dental irrigator body, the water outlet end of the water inlet pipe is sealingly docked with the water inlet of the dental irrigator body .

9. The dental irrigator according to claim 8, wherein the water inlet pipe is a rigid tube integrally formed with the dental irrigator water tank.

10. The dental irrigator according to claim 8, wherein the water inlet pipe is a hose fixedly connected to an inner cavity wall of the dental irrigator water tank.

11. The dental irrigator according to claim 8, wherein the water inlet end of the water inlet pipe is provided with a filter hole.

12. The dental irrigator according to claim 10, wherein the water outlet end of the water inlet pipe extends to a top wall of an inner cavity of the dental irrigator water tank;
the outer wall of the dental irrigator body is provided with a connecting column extending downward, and the water inlet is provided in the connecting column; and
when the dental irrigator water tank is attached to the dental irrigator body, the connecting column is hermetically inserted into the water outlet end of the water inlet pipe.

13. The dental irrigator according to claim 4, wherein the dental irrigator body comprises a nozzle, and a water outlet channel is further provided in the dental irrigator body; the nozzle is detachably provided at an upper end of the dental irrigator body and communicated with a water outlet end of the water outlet channel; an outer wall of the nozzle is provided with a limiting flange, and the limiting flange is close to a water inlet end of the nozzle; a water inlet end of the water outlet channel is communicated with a water outlet end of the pump body;
wherein a top wall of the dental irrigator water tank is provided with a mounting hole extending toward an inner cavity of the dental irrigator water tank, and a bottom wall of the mounting hole is provided with a through hole;
when the nozzle is removed from the dental irrigator body and a water outlet end of the nozzle is inserted into the inner cavity of the dental irrigator water tank after penetrating the through hole, the limiting flange of the nozzle abuts the bottom wall of the mounting hole; and
when the dental irrigator water tank is attached to the dental irrigator body, the mounting hole is sealingly engaged with the dental irrigator body.

14. The dental irrigator according to claim 13, wherein the dental irrigator body further comprises a protective cover; the protective cover is provided on the upper end of the dental irrigator body when the nozzle is in a storage state.
